(19) United States
(12) Patent Application Publication
(10) Pub. No.: US 2017/0024529 A1
(43) Pub. Date: Jan. 26, 2017

(54) Semi-Supervised Learning Framework based on Cox and AFT Models with L1/2 Regularization for Patient's Survival Prediction

(71) Applicant: Macau University of Science and Technology, Macau (MO)

(72) Inventors: Yong LIANG, Macau (MO); Hua CHAI, Macau (MO); Xiao-Ying LIU, Macau (MO)

(21) Appl. No.: 15/219,484

(22) Filed: Jul. 26, 2016

Related U.S. Application Data
(60) Provisional application No. 62/197,031, filed on Jul. 26, 2015.

(51) Int. Cl. G06F 19/00; G06N 99/00; G06F 17/18; G06N 7/00

(52) U.S. Cl. CPC G06F 19/345; G06N 7/005; G06N 99/005; G06F 17/18

(57) ABSTRACT

The present invention provides a novel semi-supervised learning method based on the combination of the Cox model and the accelerated failure time (AFT) model, each of which is regularized with L_{1/2} regularization for high-dimensional and low sample size biological data. In this semi-supervised learning framework, the Cox model can classify the “low-risk” or a “high-risk” subgroup though samples as many as possible to improve its predictive accuracy. Meanwhile, the AFT model can estimate the censored data in the subgroup, in which the samples have the same molecular genotype. Combined with L_{1/2} regularization, some genes can be selected by the Cox model and the AFT model and they are significantly relevant with the cancer.

### CROSS-REFERENCE TO RELATED APPLICATIONS

This application claims the benefit of U.S. Provisional Patent Application No. 62/197,031, filed on Jul. 26, 2015, which is incorporated by reference herein in its entirety.

### BACKGROUND

### Field of the Invention

The present invention relates to a method for assessing survival risk of a patient from a plurality of microarray gene expression data as samples, where the samples include both completed samples and censored samples.

### LIST OF REFERENCES

There follows a list of references that are occasionally cited in the specification. Each of the disclosures of these references is incorporated by reference herein in its entirety.
[1] Cox, D. R. (1975), Partial likelihood, Biometrika, 62, 269-762.
[2] Wei, L. J. (1992), The accelerated failure time model: a useful alternative to the Cox regression model in survival analysis, MedicineStat, 11, 1871-1879
[3] Chapelle, O., et al. (2008), Optimization techniques for semi-supervised support vector machines. J Mach Learn Res, 9, 203-233.
[4] Bair, E., and Tibshirani, R. (2004), Semi-supervised methods to predict patient survival from gene expression data. PLoS Biol., 2, E108.
[5] Tibshirani, R., et al. (2002), Diagnosis of multiple cancer types by shrunken centroids of gene expression, Proc. Natl. Acad. Sci. USA, 99, pp. 6567-6572.
[6] Golub, T., et al. (1999), Molecular classification of cancer: class discovery and class prediction by gene expression monitoring. Science, 286:531-537
[7] Tsiatis, A. (1996), Estimating regression parameters using linear rank tests for censored data. Ann. Stat, 18, 305-328.
[8] Datta, S. (2005), Estimating the mean life time using right censored data. Stat. Methodol, 2, 65-69.
[9] Luan, Y., and Li, H. (2004), Model-based methods for identifying periodically expressed genes based on time course microarray gene expression data. Bioinformatics, 20: 332-339.
[10] Gui, J., and Li, H. (2005), Threshold gradient descent method for censored data regression, with applications in pharmacogenomics. Pacific Symposium on Biocomputing, 10(b): 272-283.
[11] Gui, J., and Li, H. (2005), Penalized Cox regression analysis in the high-dimensional and low-sample size settings, with applications to microarray gene expression data. Bioinformatics, 21(a):3001-3008.
[12]Liu, C., et al. (2014), The L1/2 regularization method for variable selection in the Cox model. Appl. Soft Comput., 14(c), 498-503.
[13]Cox, D. R. (1972), Regression models and life-tables. J. R. Statist. Soc., 34(b), 187-220.
[14]Ernst, J., et al. (2008), A semi-supervised method for predicting transcription factorgene interactions in Escherichia coli. Plos Comput Biol, 4(3).
[15] Xu. Z. B, et al. (2012), L1/2 Regularization: A Thresholding Representation Theory and a Fast Solver. IEEE Transactions on Neural Networks and Learning Systems, 23 (7): 1013-1027
[16] Gui, J. and Li, H. (2005), Penalized Cox regression analysis in the high-dimensional and low sample size settings, with applications to microarray gene expression data. Bioinformatics, 21.
[17]Bender, R., et al. (2005), Generating survival times to simulate Cox proportional hazards models. Statistics in Medicine, 24, 1713-1723.
[18]Rosenwald, A., et al. (2002), The use of molecular profiling to predict survival after chemotherapy for diffuse large B-cell lymphoma. N. Engl. J. Med, 346, 1937-1946.
[19]Rosenwald, A., et al. (2003), The proliferation gene expression signature is a quantitative integrator of oncogenic events that predicts survival in mantle cell lymphoma. CancerCell, 3,185-197.
[20]Beer, D. G., et al. (2002), Gene-expression profiles predict survival of patients with lung adenocarcinoma. Nat. Med, 8, 816-824.
[21]Bullinger, L., et al. (2004), Use of gene-expression profiling to identify prognostic subclasses in adult acute myeloid leukemia. N. Engl. J. Med., 350, 1605-1616.
[22]Fan, J., and Li, R. (2002), Variable selection for Cox's proportional hazards model and frailty model. Ann. Statist, 30, 74-99.
[23] Wallentin, L., et al. (2013), GDF-15 for prognostication of cardiovascular and cancer morbidity and mortality in men. PLoS One, 8:12.
[24]Hatakeyama, K., et al. (2012), Placenta—Specific novel splice variants of Rho GDP dissociation inhibitor beta are highly expressed in cancerous cells. BMC Res. Notes, 5, 666.
[25]Riker, et al. (2008), The gene expression profiles of primary and metastatic melanoma yields a transition point of tumor progression and metastasis. BMC Med. Genomics, 1, p. 13.
[26] Ailan, H., et al. (2009), Identification of target genes of transcription factor activator protein 2 gamma in breast cancer cells. BMC Cancer, 9: 279.
[27] Jang, S. G., et al. (2007), GSTT2 promoter polymorphisms and colorectal cancer risk. BMC Cancer, 7: 16.

### Description of Related Art

An important objective of clinical cancer research is to develop tools to accurately predict the survival time and risk profile of patients based on the DNA microarray data and various clinical parameters. There are several existing techniques in the literature for performing this type of survival analysis. Among them, both Cox proportional hazards model (Cox) [1] and the accelerated failure time model (AFT) [2] have been widely used. Cox model is the most popular approach by far in survival analysis to assess the significance of various genes in the survival risk of patients through the hazard function. On the other hand, the requirement for analyzing failure time data arises in investigating the relationship between a censored survival outcome and high-dimensional microarray gene expression profiles. Therefore, the AFT model has been studied extensively in recent years. However, various current cancer survival analysis mechanisms have not demonstrated themselves to be very accurate as expected. The accuracy problems, in essence, are related to some fundamental dilemmas in cancer survival analysis. We believe that any attempt to improve the accuracy of survival analysis method has to compromise between these two dilemmas.

The first dilemma is related to the small sample size and the censoring of survival data versus high dimensional covariates in the Cox model.

High-dimensional survival analysis in particular has attracted much interest due to the popularity of microarray studies involving survival data. This is statistically challenging because the number of genes, p, is typically hundreds of times larger than the number of microarray samples, n (p>>n). For survival analysis, the sample size is further reduced significantly by the availability of follow-up data for the analyzed samples. In fact, in publicly available gene expression databases, only a small fraction of human-tumor microarray datasets provides clinical follow-up data. A “low-risk” or “high-risk” classification based on the Cox model usually relies on traditional supervised learning techniques, in which only completed data (i.e. data from samples with clinical follow-up) can be used for learning, while censored data (i.e. data from samples without clinical follow-up) are disregarded. Thus, the small sample size and the censoring of survival data remain a bottleneck in obtaining robust and accurate classifiers with the Cox model. Recently, a technique called semi-supervised learning [3] in machine learning suggests that censored data, when used in conjunction with a limited amount of completed data, can produce considerable improvement in learning accuracy. Indeed, semi-supervised learning has been proved to be effective in solving different biological problems. For example, “corrected” Cox scores were used for semi-supervised prediction using the principal component regression by Bair and Tibshirani [4] and the semi-supervised classification using nearest-neighbor shrunken centroid clustering by Tibshirani et al. [5].

The second dilemma is related to the similar phenotype disease versus different genotype cancer in the AFT model.

In the accelerated failure time model, to increase the available sample size and get the more accurate result, each censored observation time is replaced with the imputed value using some estimators, such as the inverse probability weighting (IPW) method, mean imputation method, Buckley-James method and rank-based method. In fact, these estimation methods assume that the AFT model was used for the patients with similar phenotype cancer, and the survival times should satisfy the same unspecified common probability distribution. Nevertheless, the disparity we see in disease progression and treatment response can be attributed to that the similar phenotype cancer may be completely different diseases on the molecular genotype level. Therefore, we need to identify different cancer genotypes. Can we do it based exclusively on the clinical data? For example, patients can be assigned to a “low-risk” or a “high-risk” subgroup based on whether they were still alive or whether their tumour had metastasized after a certain amount of time. This approach has also been used to develop procedures to diagnose patients [6]. However, by dividing the patients into subgroups just based on their survival times, the resulting subgroups may not be biologically meaningful. Suppose, for example, the underlying cell types of each patient are unknown. If we were to assign patients to “low-risk” and “high-risk” subgroups based on their survival times, many patients would be assigned to the wrong subgroup, and any future predictions based on this model would be suspect.

There is a need in the art to have a more accurate classification method by identifying these underlying cancer subtypes based on microarray data and clinical data together so as to build a model that can determine which subtype is present in patients.

### SUMMARY OF THE INVENTION

An aspect of the present invention is to provide a computer-implemented method for selecting a significant relevant gene set correlated to a clinical variable from a plurality of microarray gene expression data as samples. The samples are separated into completed samples and censored samples. The completed samples collectively give a plurality of completed data.

The method comprises repeating an iterative process for a number of instances. When the first instance of the iterative process is executed, the plurality of completed data forms a first current set of informative data used in the execution.

The iterative process comprises the following steps:
(a) applying a L_{1/2} regularized Cox model on the first current set of informative data to select a first group of genes correlated to the clinical variable;
(b) based on the first group of genes, classifying each of the samples into a risk class selected from a set of pre-determined risk classes;
(c) computing a first imputed value for an individual censored sample based on the data in the first current set of completed data and having the same risk class with the individual censored sample, whereby a plurality of first imputed values is formed;
(d) using a L_{1/2} regularized accelerated failure time (AFT) model to process a second current set of informative data so as to select a second group of genes correlated to the clinical variable, wherein the second current set of informative data is formed by augmenting the plurality of completed data and the plurality of first imputed values;
(e) based on the second group of genes, re-evaluating and hence updating the risk class of each of the samples;
(f) computing a second imputed value for the individual censored sample based on the data in the second current set of informative data and having the same risk class with the individual censored sample, whereby a plurality of second imputed values is formed; and
(g) updating the first current set of informative data with a set that augments the plurality of completed data and the plurality of second imputed values.

Other aspects of the present invention are disclosed as illustrated by the embodiments hereinafter.

### BRIEF DESCRIPTION OF THE DRAWINGS

FIG. 1 depicts a workflow for the development and evaluation of the semi-supervised learning framework, as disclosed herein, for survival analysis.

FIG. 2 shows the percentages of different types of data processed by the semi-supervised learning model in simulated experiments.

FIG. 3 shows the percentages of correct and error classification obtained by the disclosed semi-supervised learning model in simulated experiments.

FIG. 4 shows the percentages of different types of samples in original datasets and the datasets processed by the disclosed semi-supervised learning method.

FIG. 5 shows the integrated brier scores obtained by the Cox and AFT models with and without the disclosed semi-supervised learning approach for the four gene expression datasets.

FIG. 6 shows the concordance indices obtained by the Cox and AFT models with and without semi-supervised learning approach for the four gene expression datasets.

FIG. 7 shows the numbers of genes selected by the Cox and AFT models with and without semi-supervised learning approach for the four gene expression datasets.

FIG. 8 depicts the survival curves of the Cox model with and without the semi-supervised learning method for AML dataset.

### DETAILED DESCRIPTION

The approach adopted in the present invention is to strike a tactical balance between the two contradictory dilemmas mentioned above. We propose a novel semi-supervised learning method based on the combination of Cox and AFT models with L_{1/2} regularization for high-dimensional and low sample size biological data. In this semi-supervised learning framework, the Cox model can classify the “low-risk” or a “high-risk” subgroup though samples as many as possible to improve its predictive accuracy. Meanwhile, the AFT model can estimate the censored data in the subgroup, in which the samples have the same molecular genotype. Combined with L_{1/2} regularization, some genes can be selected by Cox and AFT models and they are significantly relevant with the cancer.

Before elaborating the disclosed method, we provide some backgrounds on related techniques, on the basis of all of which the disclosed method is developed.

### A. Methods Involved in the Development of Present Invention

### A.1 Cox Proportional Hazards Model (Cox)

The Cox proportional hazards model is now the most widely used for survival analysis to classify the patients into a “low-risk” or a “high-risk” subgroup after prognostic. Under the Cox model, the hazard function for the covariate matrix x={x₁, x₂, . . . , xᵢ, . . . xₙ} with a sample size n and the number of genes p is specified as λ(t)=λ₀(t)exp(β′x), where t is the survival time, β′ is the coefficient vector of x, and the baseline hazard function λ₀(t) is common to all subjects, but is unspecified or unknown. Let an ordered risk set at time t₍ᵣ₎ be denoted by Rᵣ={j∈1, . . . , n:tⱼ≧t₍ᵣ₎}. Assume that censoring is non informative and that there are no tied event times. The Cox log partial likelihood can then be defined as

$$l ( β ) = \frac{1}{n} {\sum }_{r ∈ D} ln ( \frac{exp ( {β}^{′} {x}_{( r )} )}{{\sum }_{j ∈ {R}_{r}} exp ( {β}^{′} {x}_{j} )} ) \qquad ( 1 )$$

where D denotes the set of indices for observed events.

### A.2 Accelerated Failure Time Model (AFT)

The AFT model is a linear regression model for survival analysis, in which the logarithm of response tᵢ is related linearly to covariates xᵢ:

h(tᵢ)=β₀+x′ᵢβ+εᵢ, i=1, . . . , n, (2)

where h(·) is the log transformation or some other monotone function. In this case, the Cox assumption of multiplicative effect on a hazard function is replaced with the assumption of multiplicative effect on an outcome. In other words, it is assumed that the variables xᵢ's act multiplicatively on time and therefore affect the rate at which individual i proceeds along the time axis. Because censoring is present, the standard least squares approach cannot be employed to estimate the regression parameters in (2) even when p<n. One approach for AFT model implementation entails the replacement of censored tᵢ with imputed values. One such approach is that of mean imputation in which each censored tᵢ is replaced with the conditional expectation of tⱼ given tⱼ>tᵢ[7]. The imputed value h(tᵢ) can then be given by

$$h ( {t}_{i}^{*} ) = ( {δ}_{i} ) h ( {t}_{i} ) + ( 1 - {δ}_{i} ) {\{ \hat{S} ( {t}_{i} ) \}}^{- 1} {\sum }_{{t}_{( r )} > {t}_{1}} h ( {t}_{( r )} ) Δ \hat{S} ( {t}_{( r )} ) \qquad ( 3 )$$

where Ŝ is the Kaplan-Meier estimator (Kaplan and Meier (1958), Nonparametric estimation from incomplete observations, Journal of the American Statistical Association, Vol. 53, pp. 457-81) of the survival function and where ΔŜ(t₍ᵣ₎) is the step of Ŝ at time t₍ᵣ₎. Ref. [8] also assessed the performance of several approaches to AFT model implementation, including reweighting the observed tᵢ, replacement of each censored tᵢ with an imputed observation, drawn from the conditional distribution of t (multiple imputation), and mean imputation. They found that the mean imputation approach outperformed reweighting and multiple imputation under the lasso penalization in the high-dimensional and low-sample size setting.

### A.3 L_{1/2} Regularization

In recent years, various regularization methods for survival analysis under the Cox and AFT models have been proposed, which perform both continuous shrinkage and automatic gene selection simultaneously. For example, Cox-based methods utilizing kernel transformations [9], threshold gradient descent minimization [10] and lasso penalization [11] have been proposed. Likewise, some researchers have proposed variable selection methods based on accelerated failure time models. Most of these procedures are based on the L₁-norm, however, the results of L₁ regularization are not good enough for sparsity, especially in biology research. Theoretically, the L_{q} (0<q<1) type regularization with a lower value of q would lead to better solutions with more sparsity. Moreover, among L_{q} regularizations with q∈(0,1), only L_{1/2} and L_{2/3} regularizations permit an analytically expressive thresholding representation. The inventors' previous works have also demonstrated the efficiencies of L_{1/2} regularization for the Cox and AFT models, respectively [12]. The sparse L_{1/2} regularization model is expressed as:

$$β = argmin \{ l ( β ) + λ {\sum }_{j = 1}^{p} {\vert {β}_{j} \vert}^{1 / 2} \} \qquad ( 4 )$$

where l is a loss function and λ is a tuning parameter. Since the penalty function of L_{1/2} regularization is non-convex, which raises numerical challenges in fitting the Cox and AFT models. Recently, coordinate descent algorithms [13] for solving non-convex regularization approach (such as SCAD, MCP) have been shown to have significant efficiency and convergence [14]. The algorithms optimize a target function with respect to a single parameter at a time, iteratively cycling through all parameters until reaching convergence. Since the computational burden increases only linearly with the number of the covariates p, coordinate descent algorithms can be a powerful tool for solving high-dimensional problems.

Therefore, in this work, we introduce a novel univariate half thresholding operator of the coordinate descent algorithm for the L_{1/2} regularization, which can be expressed as:

$${β}_{j} = \{ \begin{matrix}\frac{2}{3} {ω}_{j} [ 1 + cos ( \frac{2 ( π - {ϕ}_{λ} ( {ω}_{j} ) )}{3} ) ] & if \vert {ω}_{j} \vert > \frac{\sqrt[3]{54}}{4} {λ}^{2 / 3} \\ 0 & otherwise\end{matrix} \qquad ( 5 )$$

where \tilde{y}ᵢ^{(j)}Σₖ₌ⱼxᵢₖβₖ is the partial residual for fitting βⱼ, ωⱼ=Σᵢ₌ₗⁿxᵢⱼ(yᵢ−\tilde{y}ᵢ^{(j)}), and

$$\sqrt[3]{54} \cdot {λ}^{2 / 3} / 4.$$

Remark: In previous work [15], we used ¾λ^{2/3} for representing L_{1/2} regularization thresholding operator. Here, we introduce a new half thresholding representation

$${ϕ}_{λ} ( {ω}_{j} ) = arccos ( \frac{λ}{8} {( \frac{\vert {ω}_{j} \vert}{3} )}^{- 3 / 2} ) .$$

This new value is more precisely and effectively than the old one. Since it is known that the quantity of the solutions of a regularization problem depends seriously on the setting of the regularization parameter λ. Based on this novel thresholding operator, when λ is chosen by some efficient parameters tuning strategy, such as cross-validation, the convergence of the algorithm is proved [16].

### B. Semi-Supervised Learning Method

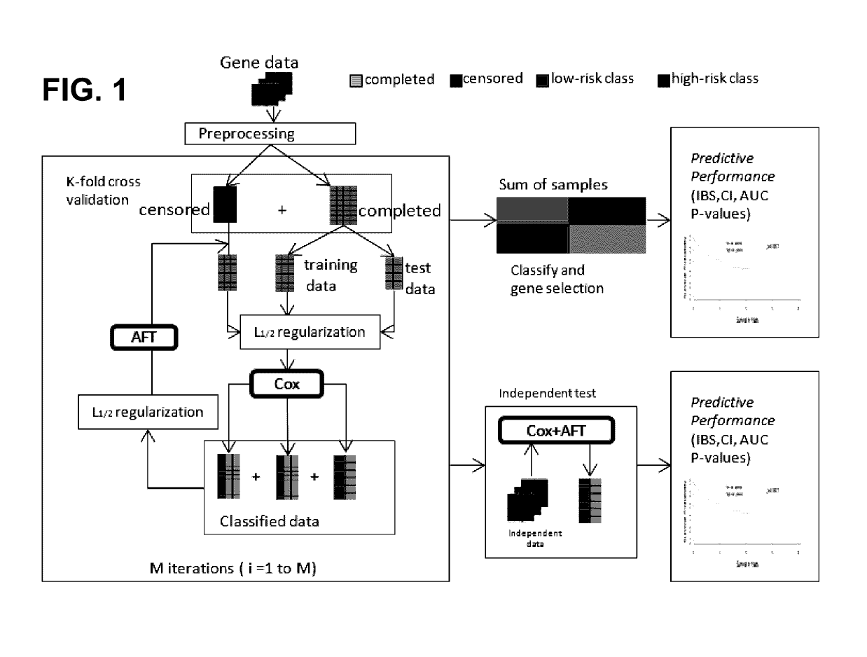

FIG. 1 illustrates the overview of our proposed semi-supervised learning development and evaluation workflow. Microarray gene expression data on a specific cancer type are collected, processed, and separated into completed samples and censored samples. In order to identify tumor subclasses that were both biologically meaningful and clinically relevant, we applied the L_{1/2} regularized Cox model on the completed data to select a group of outcome-related genes firstly. Thus, all samples including completed and censored cases can be subsequently classified into “low-risk” and “high-risk” classes. Once such classes are identified, we can evaluate the censored data using the mean imputation approach based on the completed data belonged to the same risk classes, because they are correlated to similar disease biologically meaningful at the molecular level. When the censored data replaced by the appropriate imputation values, the L_{1/2} regularized AFT model can be used to select a list of genes that correlate with the clinical variable of interest, and reevaluate the censored data based on these selected genes. A stratified K-fold cross-validation is used for regularization parameter tuning. As such, we repeated this semi-supervised learning procedure including Cox and AFT steps multiple times with an increasing number of available training data and estimating the censored data based on the similar genotype disease.

In the semi-supervised learning framework as disclosed herein, the predictive accuracy of the Cox and AFT models would be improved because the number of the training data increased and the censored data were imputed reasonably. The L_{1/2} regularization approach can select the significant relevant gene sets based on the Cox and AFT models respectively.

In the disclosed semi-supervised learning method, the censored data are evaluated from the same risk class to improve prediction performance. However, there are some observable errors in the imputations of the censored data. For example, the estimated survival time by the AFT model was even less than the censored time. We regarded them as error estimations, and did not use them for model training.

### C. Simulation Analysis of the Disclosed Method by Real Microarray Datasets

### C.1 Simulated Experiment

To evaluate the performance of our proposed semi-supervised learning method based on Cox and AFT models with L_{1/2} regularization, we adopted the simulation scheme in R. Bender's work [17]. The generation procedure of the simulated data is as follows.

Step 1: We generate γᵢ₀, γᵢ₁, . . . , γᵢₚ(i=1, . . . , n) independently from a standard normal distribution and set: Xᵢⱼ=γᵢⱼ\sqrt{1−ρ}+γᵢ₀\sqrt{ρ}(j=1, . . . , p) where ρ is the correlation coefficient.

Step 2: The survival time yᵢ is written as:

$${y}_{i} = \frac{1}{α} log ( 1 - \frac{α \cdot log ( U )}{ω \cdot exp ( β X )} )$$

in which U is a uniformly distributed variable, ω is the scale parameter, and α is the shape parameter.

Step 3: The censoring time point y′ᵢ (i=1, . . . , n) is obtained from a random distribution E(θ), where θ is determined by a specified censoring rate.

Step 4: Here we define yᵢ=min(yᵢ, y′ᵢ) and δᵢ=1,if yᵢ<y′ᵢ, else δᵢ=0, the observed data represented as (yᵢ, xᵢ, δᵢ) for the model are generated.

In our simulated experiments, we build high-dimensional and low sample size datasets. In every dataset, the dimension of the predictive genes is p=1000, in which 10 prognostic genes and their corresponding coefficients are nonzero. The coefficients of the remaining 990 genes are zero. About 40% of the data in each subgroup are right censored. We considered the training sample sizes are n=100, 200, 300 and the correlation coefficients of genes are ρ=0 and ρ=0.3 respectively. The simulated data were applied to the single Cox, single AFT and semi-supervised learning approach with Cox and AFT models. For gene selection, we use L_{1/2} regularization approach and the regularization parameters are tuned by 5-fold cross validation. To assess the variability of the experiment, each method is evaluated on a test set including 200 samples, and replicated over 50 random training and test partitions.

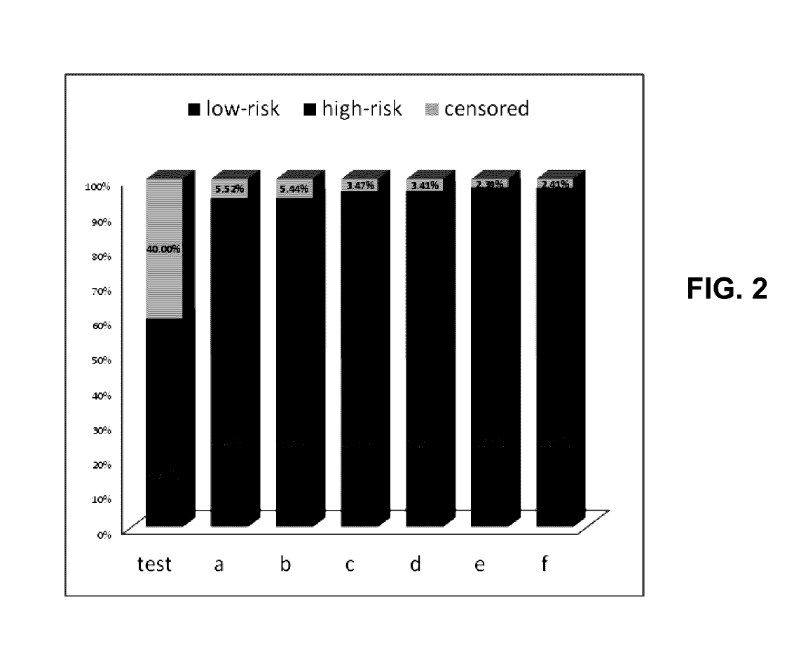

FIG. 2 shows the percentage of data distribution processed by our semi-supervised learning model with L_{1/2} regularization in different parameter settings (a: n=100, ρ=0.3; b: n=100, ρ=0; c: n=200, ρ=0.3; d: n=200, ρ=0; e: n=300, ρ=0.3; f: n=300, ρ=0). The first cylinder represents the simulated dataset, and the cylinders a-f present the form of the dataset processed by our semi-supervised learning model. Compared to the original dataset, the most censored data can be reasonable estimated to the available data by semi-supervised learning model. For example, when the training sample n=300 and the correlation coefficient ρ=0, just 2.41% censored data cannot conjugate into the available samples because their imputed survival time based on the AFT model is smaller than their observed censored time. Moreover, we can see that with the sample size increases or the correction coefficient decreases, more censored data can be correctly estimated to available training data.

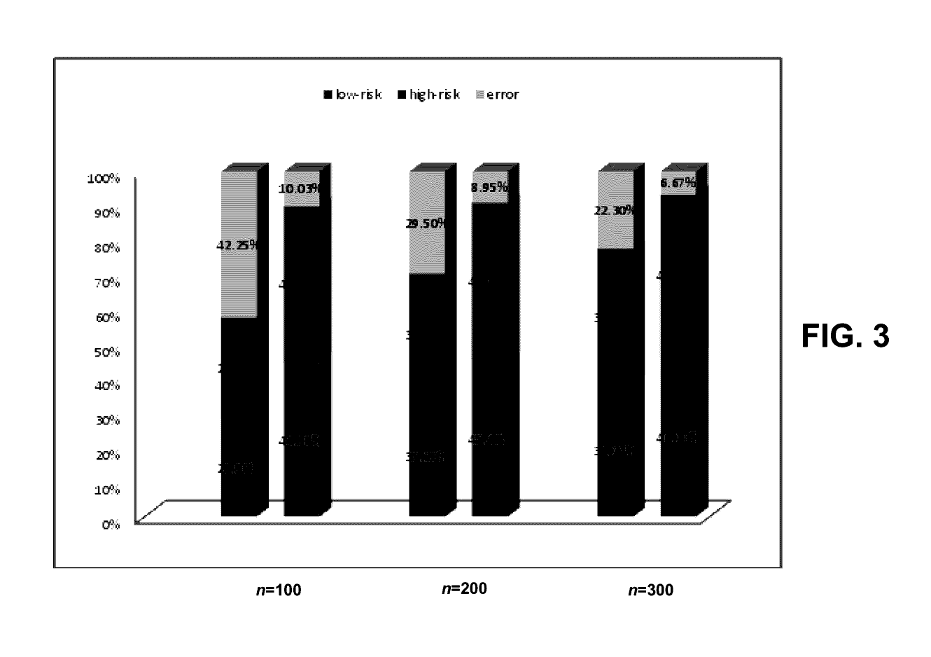

The classification accuracy under the correlation coefficient ρ=0.3 with different training sample size setting was demonstrated in FIG. 3, the sum of red and blue part represent the samples which can be correctly classified by the Cox model. The first cylinder in each group represents the result obtained by Cox model, and the second one represents the result obtained by our semi-supervised learning model. No matter in which group, the semi-supervised learning model obtained the high improvements of the classification performance. When the training sample size n=100, 200, 300, more than 32.23%, 20.55% and 15.63% samples were correctly classified by semi-Cox model when comparing with the results of the single Cox model.

The precision of our semi-supervised learning model with L_{1/2} regularization is given in Table 1.

TABLE 1
Performance of the Cox and AFT models with and without the
semi-supervised learning approach in simulated experiment.

| | | Cox | | | Semi-Cox | | |
|---|---|---|---|---|---|---|---|
| | | | | preci- | | | preci- |
| Cor. | Size | correct | selected | sion | correct | selected | sion |
| ρ = 0 | 100 | 4.06 | 24.44 | 0.166 | 6.58 | 16.96 | 0.388 |
| | 200 | 5.62 | 28.22 | 0.199 | 8.68 | 17.84 | 0.487 |
| | 300 | 8.02 | 35.18 | 0.228 | 9.76 | 19.02 | 0.513 |
| ρ = 0.3 | 100 | 3.90 | 24.38 | 0.159 | 6.46 | 17.08 | 0.378 |
| | 200 | 5.68 | 29.64 | 0.192 | 8.62 | 17.86 | 0.483 |
| | 300 | 7.84 | 35.86 | 0.219 | 9.42 | 18.54 | 0.508 |
| | | AFT | | | Semi-AFT | | |
| | | | | preci- | | | preci- |
| | | correct | selected | sion | correct | selected | sion |
| ρ = 0 | 100 | 5.02 | 38.74 | 0.130 | 6.84 | 35.54 | 0.192 |
| | 200 | 7.12 | 46.68 | 0.152 | 8.84 | 42.16 | 0.210 |
| | 300 | 8.90 | 56.54 | 0.157 | 9.86 | 50.84 | 0.194 |
| ρ = 0.3 | 100 | 4.74 | 39.54 | 0.120 | 6.72 | 35.84 | 0.188 |
| | 200 | 6.98 | 47.02 | 0.148 | 8.78 | 44.96 | 0.195 |
| | 300 | 8.80 | 56.82 | 0.155 | 9.78 | 51.02 | 0.191 |

The precision is got from the number of correct selected genes divided the total number of selected genes by the methods. With the sample size increase or the correction coefficients of the features decrease, the classification performances of each model become better. We found the single Cox and single AFT model is difficult to select the whole correct genes in the dataset. This means these models selected too few corrected genes and many other irrelevant genes in their results. This made their prediction precision very low. Nevertheless, our semi-supervised learning model solve this problem, the precision of the semi-Cox or the semi-AFT group were both higher than that obtained by the single Cox or single AFT model. After processed by our semi supervised learning method, the number of selected correct genes was increased, and the number of total selected genes was decreased, the semi-Cox achieved about 130% improvements in precision compared to the single Cox model. Although the precision improvement of semi-AFT model is smaller than that of the semi-Cox model, it can select most correct genes under different parameter settings. Therefore, we think our semi-supervised learning method can significantly improve the accuracy of prediction for survival analyses with the high-dimensional and low sample size gene expression data.

### C.2 Analysis of Real Microarray Datasets

In this section, the disclosed semi-supervised learning approach was applied to the four real gene expression datasets respectively, such as DLBCL(2002) [18], DLBCL(2003) [19], Lung cancer [20], AML [21]. The brief information of these datasets is summarized in Table 2.

TABLE 2
Detailed information of four real gene expression datasets used in the
experiments.

| | | No. of | No. of |
|---|---|---|---|
| Datasets | No. of genes | samples | censored |
| DLBCL(2002) | 7399 | 240 | 102 |
| DLBCL(2003) | 8810 | 92 | 28 |
| Lung cancer | 7129 | 86 | 62 |
| AML | 6283 | 116 | 49 |

In order to accurately assess the performance of the semi-supervised learning approach, the real datasets were randomly divided into two pieces: two thirds of the available patient samples, which include the completed and correct imputed censored data, were put in the training set used for estimation and the remaining completed and censored patients' data would be used to test the prediction capability. We used single Cox and single AFT with L_{1/2} regularization approaches for comparisons. For each procedure, the regularization parameters are tuned by 5-fold cross validation. All results are averaged over 50 repeated times respectively.

The integrated brier score (IBS) and the concordance index (CI) measurements were used to evaluate the classification and prediction performance of Cox and AFT models in the semi-supervised learning approach.

The Brier Score (BS) [22] is defined as a function of time t>0 by:

$$BS ( t ) = \frac{1}{n} {\sum }_{i = 1}^{n} [ \frac{{\hat{S} ( t \vert {X}_{i} )}^{2} 1 ( {t}_{i} \leq t ⋀ {δ}_{i} = 1 )}{\hat{G} ( {t}_{i} )} + \frac{{( 1 - \hat{S} ( t \vert {X}_{i} ) )}^{2} 1 ( {t}_{i} > t )}{\hat{G} ( t )} ]$$

where Ĝ(·) denotes the Kaplan-Meier estimation of the censoring distribution and Ŝ(·|Xᵢ) stands to estimate survival for the patient i. Note that the BS(t) is dependent on the time t, and its values are between 0 and 1. The good predictions at the time t result in small values of BS. The IBS is given by:

$$IBS = \frac{1}{max ( {t}_{i} )} {\int }_{0}^{ma x ( {t}_{i} )} BS ( t ) d t .$$

The IBS is used to assess the goodness of the predicted survival functions of all observations at every time between 0 and max(tᵢ).

The CI can be interpreted as the fraction of all pairs of subjects which predicted survival times are correctly ordered among all subjects that can actually be ordered. By the CI definition, we can determine tᵢ>tᵢ when ƒᵢ>ƒₗ and δₗ=1 where ƒ(·) is a survival function. The pairs for which neither tᵢ>tⱼ nor tᵢ<tⱼ can be determined are excluded from the calculation of the CI. Thus, the CI is defined as

$$CI = \frac{{\sum }_{i} {\sum }_{j} 1 ( {f}_{i} < {f}_{j} ⋀ {δ}_{i} = 1 )}{{\sum }_{i} {\sum }_{j} 1 ( {t}_{i} < {t}_{j} ⋀ {δ}_{i} = 1 )} .$$

Note that the values of CI are between 0 and 1, and that the perfect predictions of the building model would lead to 1 while have a CI of 0.5 at random.

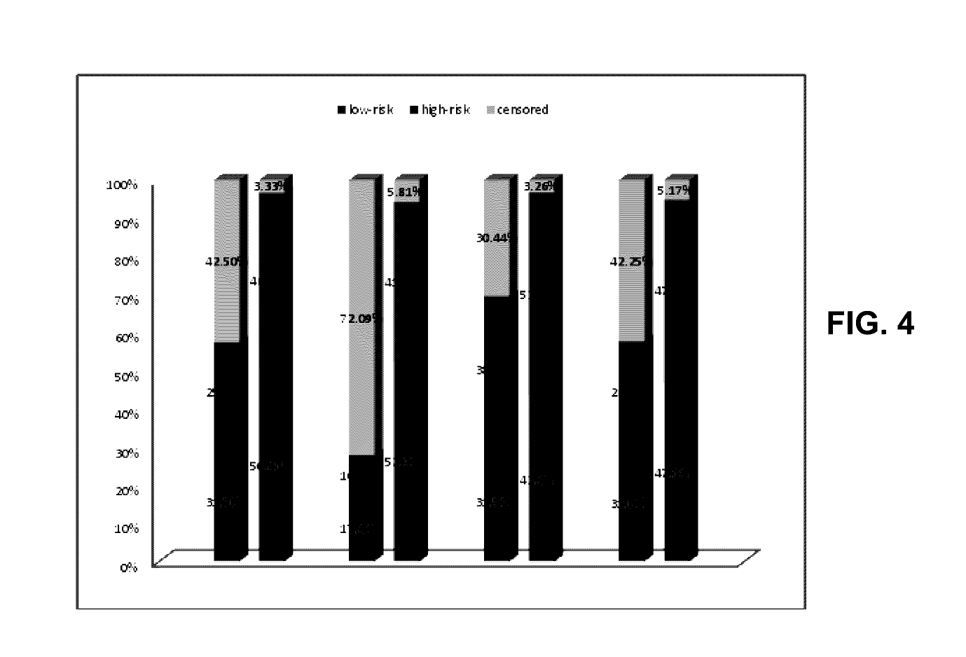

As shown in FIG. 4, the disclosed semi-supervised learning method can significantly increase the available sample size for classification model training. Especially, in Lung cancer dataset, the available samples are increased from 27.91% to 94.19%. For the other three datasets, the available sample sizes also augment from 57.50%, 69.56%, 57.75% to 96.67%, 96.73%, 94.84%, respectively. Most censored data were accurately estimated by the AFT model using samples, which belonged to the same genotype disease classes, and were sequentially classified into high-risk or low-risk classes by the Cox model, respectively. In addition of that, just a small part of the censored data cannot be conjugated into the available samples because their imputed survival times based on the AFT model are smaller than their respective observed censored times. The reason may be the individual differences of the patients.

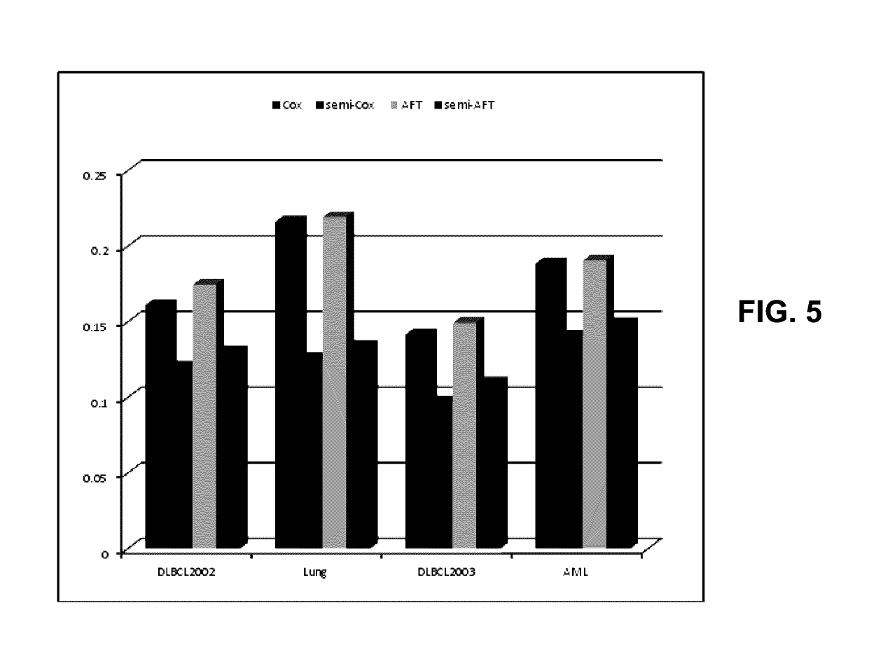

As shown in FIG. 5, the values of IBS obtained by the disclosed semi-supervised learning model with the L_{1/2} penalty were smaller than that obtained by the single Cox and AFT models. In the IBS measure, the lower value means the more accurate prediction result. For example, in the Lung cancer dataset, the IBS values of the Cox and AFT models originally from 0.2164 and 0.2195 are improved to 0.1259 and 0.1341, respectively, in the semi-supervised learning approach. For the other gene expression datasets DLBCL2002, DLBCL2003 and AML, the IBS values of the Cox model are improved by 34%, 45% and 26%, and the IBS values of the AFT model are improved by 34%, 36% and 28%, respectively. This means that the disclosed semi-supervised learning approach can significantly improve the classification and prediction accuracy of the Cox and AFT models.

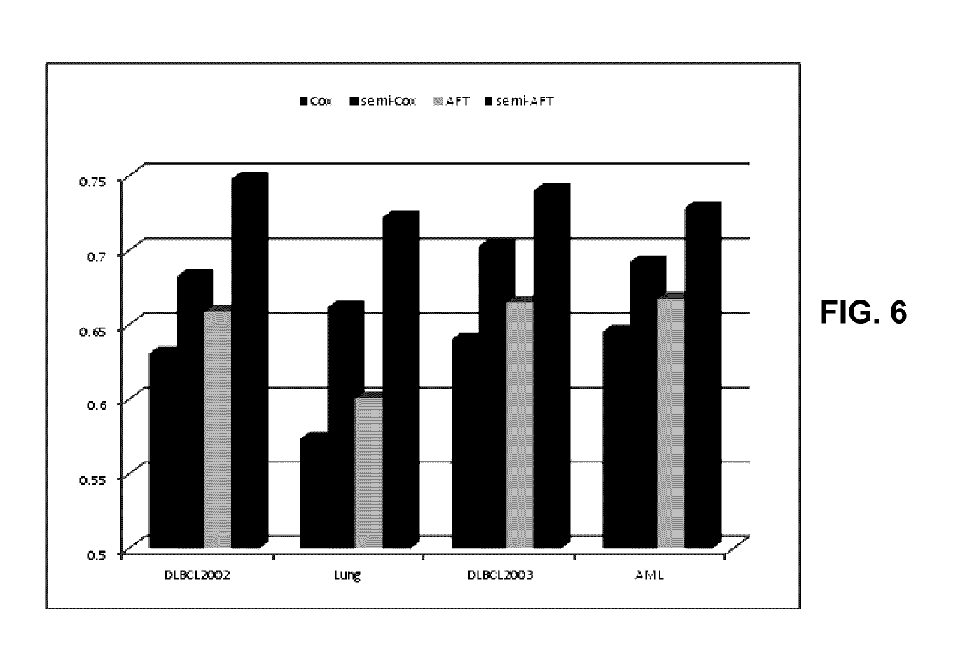

In FIG. 6, the values of CI measure obtained by the Cox and AFT with and without the semi-supervised learning approaches were given, respectively. Each CI value belongs to the region [0.5, 1] and a larger value thereof means that a more accurate prediction results. As shown in FIG. 6, for the Lung cancer dataset, the CI values of the Cox and AFT models originally from 0.5738 and 0.6013 are improved to 0.6620 and 0.7225, respectively, in the semi-supervised learning approach. The improvement rate is greater than (0.6620−0.5738)/(0.5738−0.500)=120%. For the other gene expression datasets DLBCL2002, DLBCL2003 and AML, the CI values of the Cox models are improved to 39%, 45% and 25%, and the CI values of the AFT models are improved to 56%, 45% and 36%, respectively. These results also illustrate that the semi-supervised learning method can significantly improve the accuracy of prediction in a survival analysis with the high-dimensional and low sample size gene expression data.

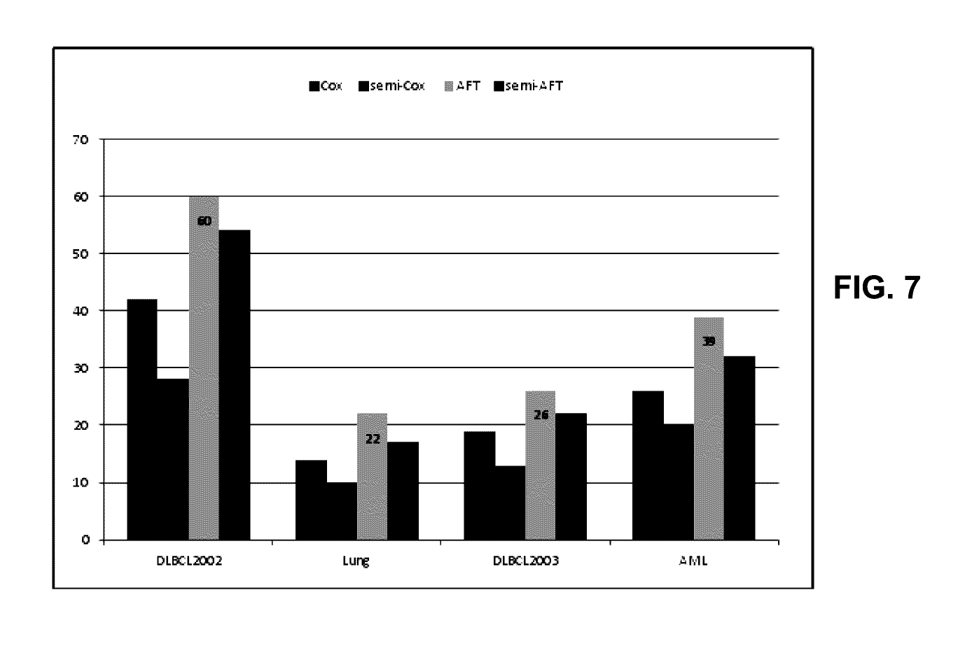

FIG. 7 gives the number of genes selected by the L_{1/2} regularized Cox and AFT models with and without the semi-supervised learning framework. The semi-Cox and semi-AFT selected less genes compared to the single Cox and AFT models. For example, in the lung cancer dataset, the single Cox and AFT models select 14 and 22 genes, respectively. However, the Cox and AFT models in semi-supervised learning model just select 10 and 17 genes. Moreover, combining the results in FIGS. 3 and 4, the prediction accuracy of Cox and AFT models in the semi-supervised learning model was significantly improved using a smaller number of the relevant genes.

On the other hand, we find that for these all four gene expression datasets, the selected genes from the Cox and AFT models are quite different and just small parts of them are overlapping. We think that the reason may be that the Cox model selects the relevant genes for low-risk and high-risk classification. Nevertheless, the genes selected by the AFT model are highly correlative with the survival time of patients. Therefore, these two models may select different genes, which have different biological functions. Through our below analyses, we know that the genes selected by semi-supervised learning methods are significantly relevant with cancer.

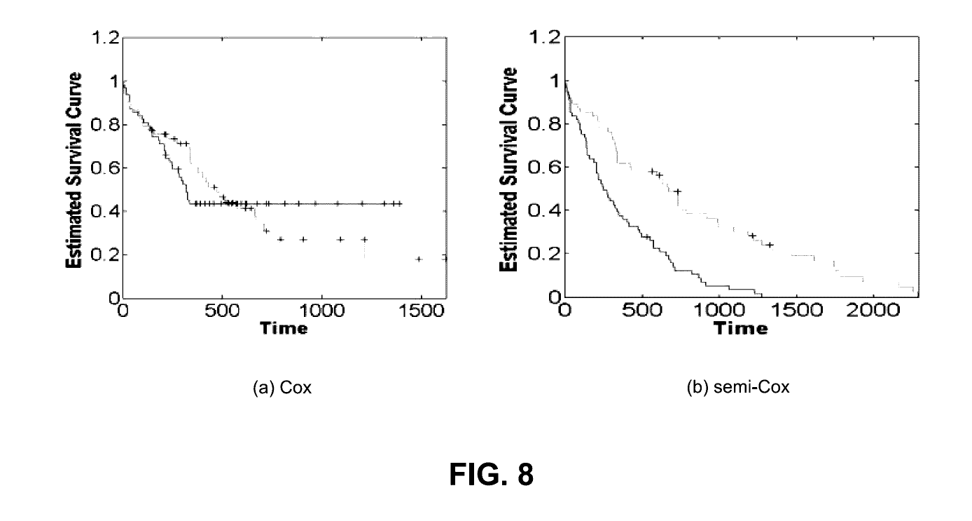

FIG. 8 shows the survival curves of the Cox model with and without the semi-supervised learning method for the AML dataset. The x-axis represents the survival days and the y-axis is the estimated survival probability. The green and the read curves represent the changes of the survival probability for the “low-risk” and “high-risk” classes, respectively. As shown in FIG. 8A, these two curves intersect at the time point of 564 days, meaning that the single Cox model cannot efficiently classify and predict the survival rate of the patients using the AML dataset. On the other hand, in FIG. 8B, the survival probabilities of the “low-risk” and “high-risk” patients can be efficiently estimated by the semi-Cox model. For other three gene expression datasets, we also obtained similar results, indicating that the classification performance of semi-Cox model significantly outperforms the single Cox model.

### C.3 Biological Analyses of the Selected Genes

In this section, we introduce a brief biological analysis of the selected genes for the Lung cancer dataset to demonstrate the superiority of our proposed semi-supervised learning method. The number of selected genes by semi-supervised learning method is less than the single Cox and AFT model, but includes some genes which are significantly associated with cancer and cannot be selected by the two single Cox and AFT models, such as GDF15, ARHGDIB and PDGFRL. GDF15 belongs to the transforming growth factor-beta superfamily, and is one kind of bone morphogenetic proteins. It was showed that GDF15 can be seen as prognostication of cancer morbidity and mortality in men [23]. ARHGDM is the member of the Rho (or ARH) protein family; it is involved in many different cell events such as cell secretion, proliferation. It is likely to impact on the cancer [24]. The role of PDGFRL is to encode a protein contains an important sequence which is similar to the ligand binding domain of platelet-derived growth factor receptor beta. Biological research has confirmed that this gene can affect the sporadic hepatocellular carcinomas. This suggests that this gene product may get the function of the tumor inhibition.

At the same time, the Cox and AFT models with and without semi-supervised learning method also selected some common genes, e.g., the PTP4A2, TFAP2C and GSTT2. PTP4A2 is the member of the protein tyrosine phosphatase family. Overexpression of PTP4A2 will confer a transformed phenotype in mammalian cells, suggesting its role in tumorigenesis [25]. TFAP2C can encode a protein contains a sequence-specific DNA-binding transcription factor which can activate some developmental genes [26]. GSTT2 is one kind of a member of a superfamily of proteins. It has been proved to play an important role in human carcinogenesis and shows that these genes are linked to cancer with a certain relationship [27].

Through the comparison of the biological analyses of the selected genes, we found the semi-supervised method based on Cox and AFT models with L_{1/2} regularization is a competitive method compared to single regularized Cox and AFT models.

### D. The Present Invention

The present invention is developed based on our proposed semi-supervised learning framework as disclosed above. An aspect of the present invention is to provide a computer-implemented method for selecting a significant relevant gene set correlated to a clinical variable from a plurality of microarray gene expression data as samples. The samples are separated into completed samples and censored samples. The completed samples collectively give a plurality of completed data.

The method comprises repeating an iterative process for a number of instances. In a start-up stage, namely, when the first instance of the iterative process is executed, the plurality of completed data forms a first current set of informative data used in the execution.

Exemplarily, the iterative process comprises the following steps.
1. A L_{1/2} regularized Cox model is applied on the first current set of informative data to select a first group of genes correlated to the clinical variable.
2. Based on the first group of genes, each of the samples is classified into a risk class selected from a set of pre-determined risk classes. Preferably, the set of pre-determined risk classes consists of a high-risk class or a low-risk class.
3. A first imputed value for an individual censored sample is computed based on the data in the first current set of completed data and having the same risk class with the individual censored sample. As a result, a plurality of first imputed values is formed.
4. A L_{1/2} regularized AFT model is used to process a second current set of informative data so as to select a second group of genes correlated to the clinical variable. The second current set of informative set that is used is formed by augmenting the plurality of completed data and the plurality of first imputed values.
5. Based on the second group of genes, the risk class of each of the samples is re-evaluated and hence updated.
6. A second imputed value for the individual censored sample is computed based on the data in the second current set of informative data and having the same risk class with the individual censored sample. Thereby, a plurality of second imputed values is formed.
7. The first current set of informative data is updated with a set that augments the plurality of completed data and the plurality of second imputed values.

Each first imputed value and each second imputed value may be determined according to a mean imputation approach. Regularization parameters used in the L_{1/2} regularized Cox model and the L_{1/2} regularized AFT model may be tuned by a stratified K-fold cross-validation. Preferably, a univariate half thresholding operator of a coordinate descent algorithm for L_{1/2} regularization is used in the L_{1/2} regularized Cox model and the L_{1/2} regularized AFT model. The univariate half thresholding operator is given by (5).

Although the method is advantageously usable to risk survival assessment for the patient with cancer, the present invention is not limited only to cancer but can be applied to other diseases.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer-implemented method for selecting a significant relevant gene set correlated to a clinical variable from a plurality of microarray gene expression data as samples, the samples being separated into completed samples and censored samples, the completed samples collectively providing a plurality of completed data, the method comprising:
repeating an iterative process for a number of instances, wherein the plurality of completed data forms a first current set of informative data when executing the first instance of the iterative process;
the iterative process comprising the steps of:
(a) applying a L_{1/2} regularized Cox model on the first current set of informative data to select a first group of genes correlated to the clinical variable;
(b) based on the first group of genes, classifying each of the samples into a risk class selected from a set of pre-determined risk classes;
(c) computing a first imputed value for an individual censored sample based on the data in the first current set of completed data and having the same risk class with the individual censored sample, whereby a plurality of first imputed values is formed;
(d) using a L_{1/2} regularized accelerated failure time (AFT) model to process a second current set of informative data so as to select a second group of genes correlated to the clinical variable, wherein the second current set of informative data is formed by augmenting the plurality of completed data and the plurality of first imputed values;
(e) based on the second group of genes, re-evaluating and hence updating the risk class of each of the samples;
(f) computing a second imputed value for the individual censored sample based on the data in the second current set of informative data and having the same risk class with the individual censored sample, whereby a plurality of second imputed values is formed; and
(g) updating the first current set of informative data with a set that augments the plurality of completed data and the plurality of second imputed values.

2. The method of claim 1, wherein the set of pre-determined risk classes consists of a high-risk class or a low-risk class.

3. The method of claim 1, wherein each first imputed value and each second imputed value are determined according to a mean imputation approach.

4. The method of claim 1, wherein regularization parameters used in the L_{1/2} regularized Cox model and the L_{1/2} regularized AFT model are tuned by a stratified K-fold cross-validation.

5. The method of claim 4, wherein each first imputed value and each second imputed value are determined according to a mean imputation approach.

6. The method of claim 1, wherein a univariate half thresholding operator of a coordinate descent algorithm for L_{1/2} regularization is used in the L_{1/2} regularized Cox model and the L_{1/2} regularized AFT model.

7. The method of claim 6, wherein each first imputed value and each second imputed value are determined according to a mean imputation approach.

8. The method of claim 6, wherein the univariate half thresholding operator is given by
$${β}_{j} = \{ \begin{matrix}\frac{2}{3} {ω}_{j} [ 1 + cos ( \frac{2 ( π - {ϕ}_{λ} ( {ω}_{j} ) )}{3} ) ] & if \vert {ω}_{j} \vert > \frac{\sqrt[3]{54}}{4} {λ}^{2 / 3} \\ 0 & otherwise\end{matrix}$$
where:
ωⱼ is given by ωⱼ=Σᵢ₌₁ⁿxᵢⱼ(yᵢ−\tilde{y}ᵢ^{(j)}), in which \tilde{y}ᵢ^{(j)}=Σₖ₌ⱼxᵢₖβₖ is a partial residual for fitting βⱼ;
φ_{λ}(ωⱼ) is given by
$${ϕ}_{λ} ( {ω}_{j} ) = arccos ( \frac{λ}{8} {( \frac{\vert {ω}_{j} \vert}{3} )}^{- 3 / 2} ) ; and$$
$$\sqrt[3]{54} \cdot {λ}^{2 / 3} / 4$$
is a half thresholding representation, λ being a regularization parameter.

9. The method of claim 8, wherein each first imputed value and each second imputed value are determined according to a mean imputation approach.
